(19) United States
(12) Patent Application Publication
(10) Pub. No.: US 2014/0117915 A1
(43) Pub. Date: May 1, 2014

(54) VARIABLE FREQUENCY DRIVE VOLTAGE BOOST TO IMPROVE UTILIZATION

(71) Applicant: Michael A. Stark, Mooresville, NC (US)

(72) Inventor: Michael A. Stark, Mooresville, NC (US)

(73) Assignee: Carrier Corporation, Farmington, CT (US)

(21) Appl. No.: 14/127,185

(22) PCT Filed: Jun. 15, 2012
(86) PCT No.: PCT/US2012/042614

§ 371 Date: Dec. 18, 2013

Related U.S. Application Data
(60) Provisional application No. 61/499,424, filed on Jun. 21, 2011.

(51) Int. Cl. H02P 27/04

(52) U.S. Cl. CPC H02P 27/04
USPC 318/504; 363/21.01

(57) ABSTRACT

A variable frequency drive system including an alternating current electrical power source, an alternating current motor and a variable frequency drive connected to the power source and the motor. The variable frequency drive provides electrical power to the motor, and includes an active rectifier to convert a first alternating current from the power source to a direct current and an inverter to convert the direct current to a second alternating current. A variable frequency drive output voltage is greater than a variable frequency drive input voltage, compensating for the motor apparent current. A method of electrical power conversion includes urging a first alternating current from a power source to a variable frequency drive. The first alternating current is converted to direct current via an active rectifier of the variable frequency drive, and the direct current is converted to a second alternating current via an inverter of the variable frequency drive.

### BACKGROUND OF THE INVENTION

The subject matter disclosed herein relates to variable frequency drives.

In typical a variable frequency drive application, an AC motor is connected to a variable frequency drive (VFD). The VFD is a solid-state power conversion device. Electrical power is input into the VFD as AC power. The AC power is converted to DC power via a rectifier utilizing one or more diodes to effect the conversion. The VFD also includes an inverter to then convert the DC power into a quasi-sinusoidal AC power, or VFD power. It is this VFD power which is output to the AC motor to drive the AC motor.

In the typical VFD application, the voltage of the AC motor is matched to an input voltage of the VFD. When considering the apparent current in this application, the inverter is operating at a proportionally higher current to compensate for a motor power factor of the AC motor, as compared to the input current of the VFD which is operating at near unity power factor. This results in the VFD being current limited by the inverter, with the rectifier then being underutilized. Because of the general purpose nature of VFDs, they are typically designed for unity power factor load, thus they have matching current requirements for rectifier and the inverter.

### BRIEF DESCRIPTION OF THE INVENTION

According to one aspect of the invention, a variable frequency drive system including an alternating current electrical power source, an alternating current motor and a variable frequency drive operably connected to the power source and the motor. The variable frequency drive provides electrical power to the motor, and includes an active rectifier to convert a first alternating current from the power source to a direct current and an inverter to convert the direct current to a second alternating current. A variable frequency drive output voltage is greater than a variable frequency drive input voltage.

According to another aspect of the invention, a method of electrical power conversion includes urging a first alternating current from a power source to a variable frequency drive. The first alternating current is converted to direct current via an active rectifier of the variable frequency drive, and the direct current is converted to a second alternating current via an inverter of the variable frequency drive. A variable frequency drive output voltage is greater than a variable frequency drive input voltage.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

The FIGURE is a schematic of an embodiment of a variable frequency drive.

The detailed description explains embodiments of the invention, together with advantages and features, by way of example with reference to the drawings.

### DETAILED DESCRIPTION OF THE INVENTION

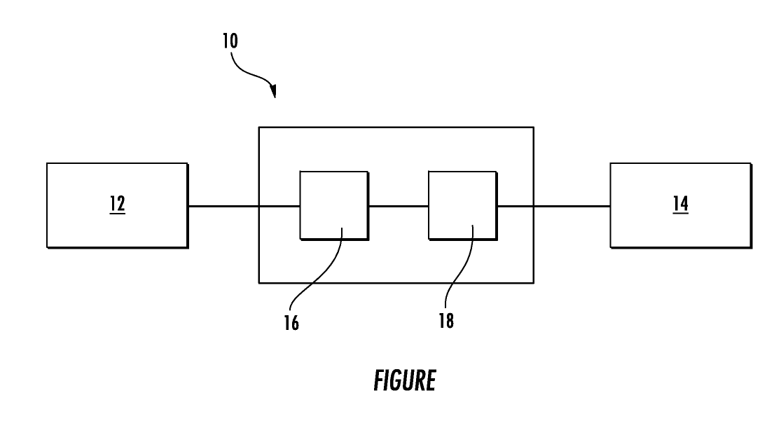

Shown in FIG. 1 is a schematic of a variable frequency drive (VFD) 10. The VFD 10 is connected to a source of AC power such as, for example, a transformer 12, and to an AC motor 14 to which power is provided from the VFD 10. The VFD 10 includes a rectifier, in particular a four quadrant/active rectifier 16 which replaces diodes of the traditional rectifier with one or more transistors, for example, MOSFETs. The active rectifier 16 converts the incoming AC power into DC power. The DC power is then converted to AC power by an inverter 18 of the VFD 10. Utilizing the active rectifier 16 in the VFD 10 results in a DC buss voltage which approaches a peak-to-peak voltage of the source AC power, which is a substantial increase over the DC buss voltage of a typical VFD. This increased DC buss voltage in turn allows an output voltage from the VFD 10 to exceed an input voltage to the VFD 10.

This benefit of utilizing the active rectifier 16 in the VFD 10 will now be explained by was of example. In a typical VFD application, a power supply with at a given voltage, V, is connected to the VFD. A current rating, I, of the typical VFD is matched to the rated load amps (RLA) of the AC motor to which it is connected. The AC motor further operates at a known power factor, P_{f}.

A power output of a VFD may be expressed as:

kW_{VFD}=1.73*V*I*P_{f}/1000

For a typical VFD application, where the VFD is rated at 500 amps, having a 400 volt power supply, and connected to a motor with an RLA of 500 amps and a power factor of 85%,

kW_{VFD}=1.73*400*500*0.85/1000=294.1 kW

On the other hand, utilizing a VFD 10 of the present invention having an active rectifier 16, a similar input voltage from the transformer 12 results in an increased power output from the VFD 10 because of an ability of the active rectifier 16 to maintain the increased DC buss voltage compared to the typical VFD. In some embodiments, the VFD 10 output voltage is increased by an inverse of P_{f}. For example, in a case where the transformer 12 outputs 400 volts, the voltage output by the VFD 10 is:

V_{VFD}=400/0.85=470.6 V

The increased voltage V_{VFD} results in an increased power output from the VFD 10. In this case,

kW_{VFD}=1.73*470.6*500*0.85/1000=346.0 kW

or an increase of 117.6% over a typical VFD.

The increase in power output from the VFD 10 over the typical VFD allows a higher voltage AC motor 14 to be coupled with a transformer 12 of a given supply voltage. This effectively reduces the current necessary through the VFD 10 allowing a smaller VFD 10 to be utilized to provide the desired output voltage.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A variable frequency drive system comprising:
an alternating current electrical power source;
an alternating current motor;
a variable frequency drive operably connected to the power source and the motor to provide electrical power to the motor, the variable frequency drive including:
an active rectifier to convert a first alternating current from the power source to a direct current; and
an inverter to convert the direct current to a second alternating current;
wherein a variable frequency drive output voltage is greater than a variable frequency drive input voltage.

2. The system of claim 1, wherein a motor voltage of the motor is substantially matched to the variable frequency drive output voltage.

3. The system of claim 1, wherein the motor has a rating of about 500 amps.

4. The system of claim 1, wherein the power source is a transformer.

5. The system of claim 1, wherein the power source has an output of about 400 volts.

6. The system of claim 1, wherein the active rectifier includes one or more transistors.

7. The system of claim 1, wherein the one or more transistors are one or more MOSFETs.

8. A method of electrical power conversion comprising:
urging a first alternating current from a power source to a variable frequency drive;
converting the first alternating current to direct current via an active rectifier of the variable frequency drive; and
converting the direct current to a second alternating current via an inverter of the variable frequency drive;
wherein a variable frequency drive output voltage is greater than a variable frequency drive input voltage.

9. The method of claim 8, further comprising urging the second alternating current to an alternating current motor.

10. The method of claim 9, wherein a motor voltage of the motor is substantially matched to the variable frequency drive output voltage.

11. The method of claim 9, wherein the output voltage is adjusted to compensate for an apparent current supported by the inverter.

12. The method of claim 9, wherein the motor has a rating of about 500 amps.

13. The method of claim 8, wherein the power source is a transformer.

14. The method of claim 8, wherein the power source has an output of about 400 volts.

15. The method of claim 8, wherein the active rectifier includes one or more transistors.

16. The method of claim 8, wherein the one or more transistors are one or more MOSFETs.
